(19) United States
(12) Patent Application Publication
(10) Pub. No.: US 2025/0285033 A1
(43) Pub. Date: Sep. 11, 2025

(54) ENSEMBLE-BASED DETECTION OF ANOMALOUS FEEDBACK IN MACHINE LEARNING MODELING

(71) Applicant: Cisco Technology, Inc., San Jose, CA (US)

(72) Inventors: Grégory MERMOUD, Venthône (CH); Jean-Philippe VASSEUR, Combloux (FR); Pierre-André SAVALLE, Rueil-Malmaison (FR); Romain KAKKO-CHILOFF, Paris (FR)

(21) Appl. No.: 18/597,791

(22) Filed: Mar. 6, 2024

(51) Int. Cl. G06N 20/20

(52) U.S. Cl. CPC G06N 20/20

(57) ABSTRACT

In one embodiment, a method herein comprises: computing a plurality of predictions based on session telemetry data for an application, each of the plurality of predictions computed by inputting a particular input of the session telemetry data into a respective machine learning model of a plurality of machine learning models; computing, for each respective feedback of a plurality of collected feedbacks correlated with the session telemetry data, a residual error vector that quantifies a level of mis-prediction of each respective machine learning model as compared to each respective feedback; clustering each residual error vector into one or more clusters based on similarity to thereby identify one or more outlier residual error vectors that are not within any of the one or more clusters; and performing one or more mitigation actions responsive to the one or more outlier residual error vectors.

### TECHNICAL FIELD

The present disclosure relates generally to computer networks, and, more particularly, to ensemble-based detection of anomalous feedback in machine learning modeling.

### BACKGROUND

The Internet and the World Wide Web have enabled the proliferation of web services available for virtually all types of businesses or applications. Due to the accompanying complexity of the infrastructure supporting the services, it is becoming increasingly difficult to maintain the highest level of service performance and user experience to keep up with the increase in web services.

Many systems today, such as voice and/or video applications, often collect user feedback about quality-of-experience (QoE). The strategy is based on directly requesting feedback from users when they are using an application, such as through simple feedback voting or through a chat bot which allows for collecting much larger datasets than any other previous method. When directly collecting data from users, however, it is important to account for potentially adverse or unreliable behaviors. For instance, a small set of users may misunderstand what is expected from them or they may always provide incorrect feedback on purpose.

This is particularly problematic in applications that build machine learning models to assess and/or optimize the QoE. In particular, although machine learning techniques can usually deal with some level of noise in the labels provided to them, too much label noise can still impact model performance. When providing overall visibility at the level of the network, such noisy labels can also lead to incorrect figures (e.g., it can lead to over-estimating the number of users with consistently poor QoE).

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for ensemble-based detection of anomalous feedback in machine learning modeling;

FIG. 6 illustrates an example system for computing a residual vector for a single sample and label;

FIG. 7 illustrates an example of a density-based spatial clustering of applications with noise (DBSCAN) in a two-dimensional space showing clusters and outliers; and

FIG. 8 illustrates an example procedure for ensemble-based detection of anomalous feedback in machine learning modeling.

### DESCRIPTION OF EXAMPLE EMBODIMENTS

### Overview

According to one or more embodiments of the disclosure, a method herein comprises: computing a plurality of predictions based on session telemetry data for an application, each of the plurality of predictions computed by inputting a particular input of the session telemetry data into a respective machine learning model of a plurality of machine learning models; computing, for each respective feedback of a plurality of collected feedbacks correlated with the session telemetry data, a residual error vector that quantifies a level of mis-prediction of each respective machine learning model as compared to each respective feedback; clustering each residual error vector into one or more clusters based on similarity to thereby identify one or more outlier residual error vectors that are not within any of the one or more clusters; and performing one or more mitigation actions responsive to the one or more outlier residual error vectors.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

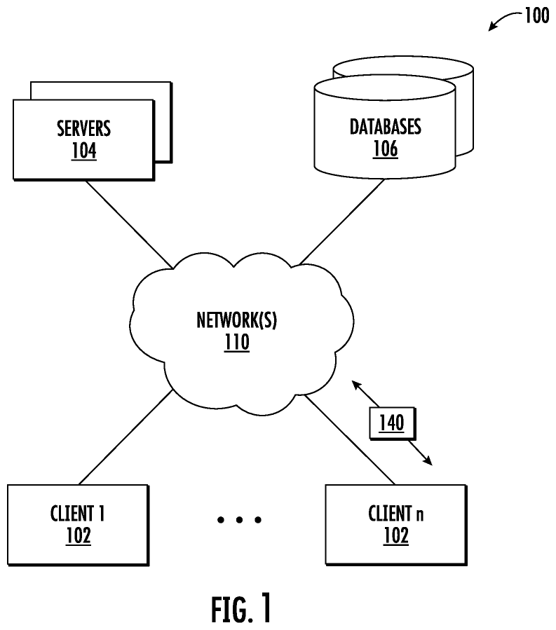

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

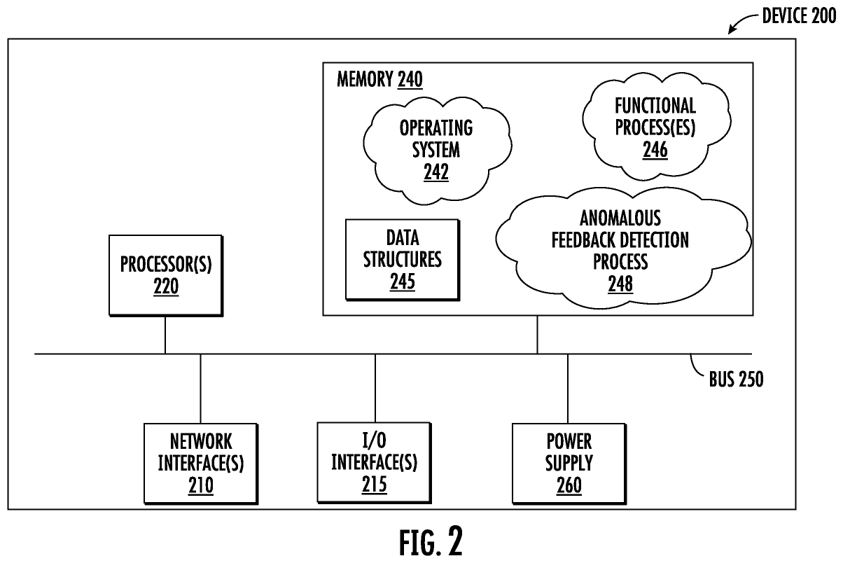

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an anomalous feedback detection process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, one or more functional processes 246 and/or anomalous feedback detection process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different quality of service (QOS) at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

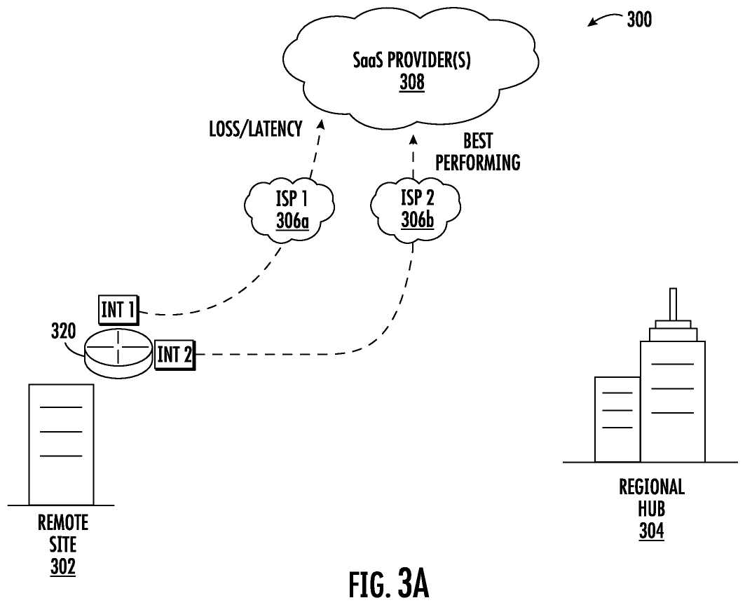

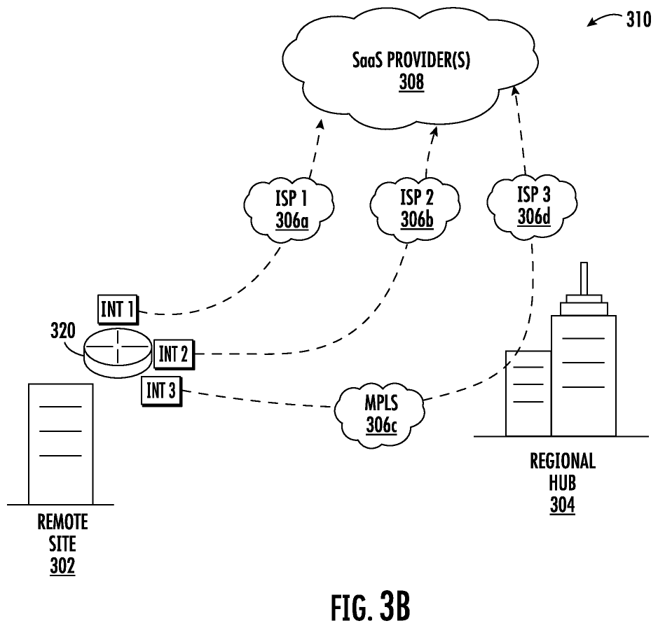

FIGS. 3A-3B illustrate example network deployments (network deployment 300, network deployment 310, respectively). As shown, a router 320 located at the edge of a remote site 302 may provide connectivity between a local area network (LAN) of the remote site 302 and one or more cloud-based, SaaS provider(s) 308. For example, in the case of an SD-WAN, router 320 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and a SaaS provider. For example, as shown in network deployment 300 in FIG. 3A, router 320 may utilize two Direct Internet Access (DIA) connections to connect with SaaS provider(s) 308. More specifically, a first interface of router 320 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 320, Int 2, may establish a backhaul path with SaaS provider(s) 308 via a second ISP 306b, denoted ISP 2 in FIG. 3A.

FIG. 3B illustrates another network deployment 310 in which Int 1 of router 320 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 320 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

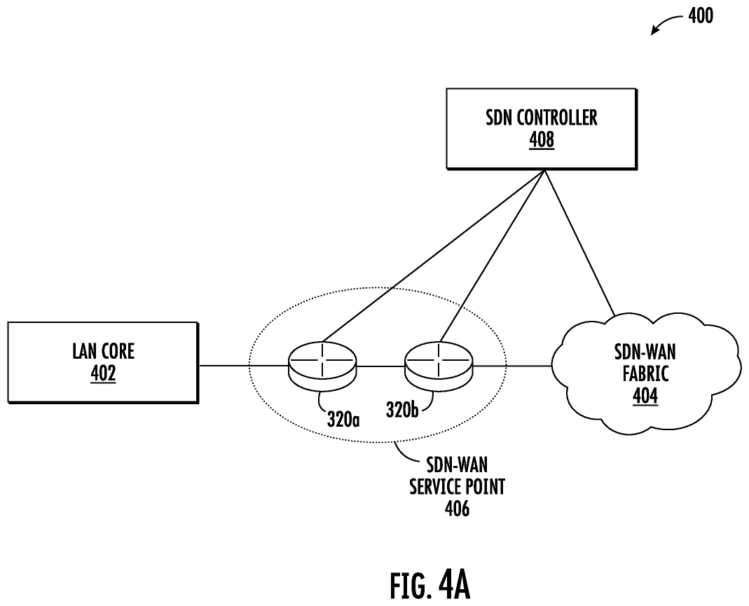

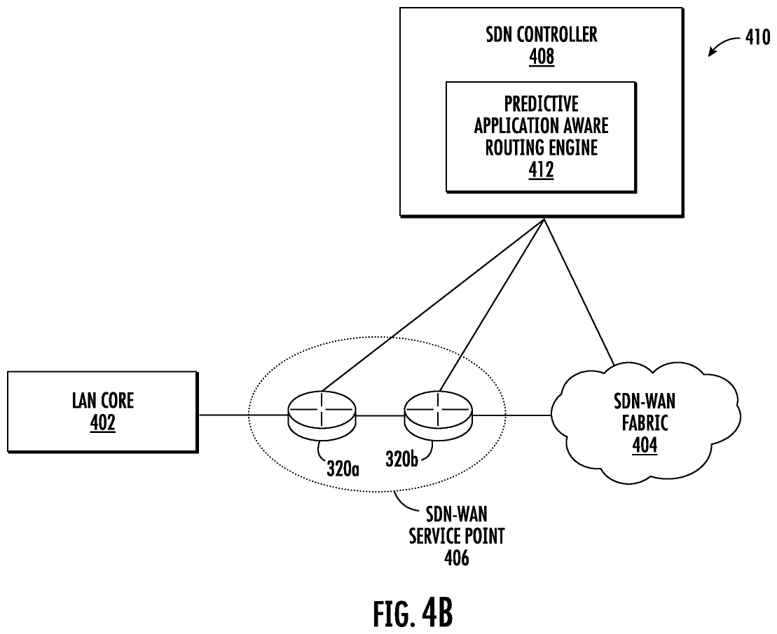

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., one or more functional processes 246), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging a SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address.

In particular, various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of QoE assessment process, process 248). Further embodiments provide for predictive application aware routing engine 412 to be hosted on a router or at any other location in the network.

During execution, predictive application aware routing engine 412 makes use of a high volume of network and application telemetry (e.g., from routers 320a-320b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, predictive networking engines, such as predictive application aware routing engine 412, seek to select the best path from among a plurality of paths P1, P2, . . . , PN such that end users of a given online application, either SaaS-delivered (e.g., WebEx, Zoom, O365, Salesforce, SAP, etc.) or datacenter-hosted (and monitored via tools such as Datadog, AppDynamics, etc.) have the best experience possible. In the context of SD-WAN, these paths may be probed for liveness and basic path QoS metrics (e.g., loss, latency, jitter, throughput, etc.) at the network level (L3), typically using technologies such as Bidirectional Forwarding Detection (BFD) probing.

However, actively probing the QoS metrics of the network paths reveals little about the actual experience of the end user. Indeed, while the path performance may be considered degraded from a networking perspective, an end user of an application may not even notice a change in their overall application experience (e.g., due to the codecs in use by the application, the ability of the application to adapt to network problems, etc.). As a result, networks today are primarily optimized using metrics such as mean opinion score (MOS) metrics, that are only vague approximations or proxies of what is thought to be the real end user experience. Furthermore, such proxies do not account at all for the inherently subjective nature of the application experience, which may be perceived differently by different users, and are not customized in any way to the individual end users. Said differently, there is a very poor understanding today of what the actual experience of an application user is.

In particular, in recent years, enterprise networks have been undergoing a fundamental transformation where users and applications have become increasingly distributed while technologies (such as SD-WAN) have enabled unprecedented flexibility in terms of network architecture and underlay connectivity options.

At the same time, collaboration applications˜critical for day-to-day business operations, have moved from on-premises deployment to a SaaS Cloud delivery model which allows application vendors and rapidly deploy and take advantage of the latest and most novel techniques and codecs that can be used to increase robustness of media content.

In this highly dynamic environment, the ability of network administrators to understand the impact of network performance (or lack of) on media applications quality of experience (QoE) and ensuring Service Level Agreements (SLAs) is becoming increasingly challenging.

How much do developers know about “user experience” and “networking actions that should be taken in order to improve user experience”? For decades the answer to the first question has been entirely relying on network Key Performance Indicator (KPIs) such as delay, loss, and jitter for which hard boundaries should not be exceeded in order to meet the application SLA. In the example of voice, the usual SLA boundaries are 150 ms for Delay, 50 ms for Jitter and a maximum of 3% of packet loss. Unfortunately, such values are highly debatable. Moreover, the measurements granularity is usually left unspecified making the values totally irrelevant. A path experiencing a constant delay of 120 ms for voice over a period of 10 minutes provides a very different user experience than a path with the same average delay that keeps varying between 20 ms and 450 ms. The dynamics of such KPIs is even more critical for packet loss and jitter in the case of voice and video traffic (e.g., 10 s of 80% packet loss would severely impact the user experience although averaged out over 10 s would give a low value totally acceptable according to the threshold). Without a doubt, the user experience requires a more subtle and accurate approach to determine the networking requirements a path should meet in order to maximize the user satisfaction, capturing local phenomenon (e.g., effects on delay, jitter, and loss at higher frequencies) but also telemetry from upper layers (applications). For years the concept of layers isolation has been a core principle of the Internet. Such an approach allowed for avoiding layer dependency (e.g., often referred to as layer violation) at a time where several protocols and technologies were developed at each layer, thus enabling the design and deployment of new layers (e.g. PHY, MAC, etc.) independent of each other, allowing the Internet to scale. Still, with modern applications requiring tight SLAs a cross-layer approach is highly desirable. The answer to the second question is equally challenging and remains unanswered. Although the effect of specific actions at a given layer of the networking stack on user experience can be qualitatively evaluated, being able to precisely quantify it is often unknown: determining that voice quality is low along a highly congested path may be relatively easy but by how much should the bandwidth be increased or the weight of the queue used for voice be tuned in order to increase the user experience score?

Cognitive Networks introduce a new approach, where instead of taking a siloed approach where networking systems poorly understand user satisfaction, focus on a single layer, and poorly connect with networking actions, Cognitive Networks are fully driven by understanding user experience (cognition) using cross-layer telemetry and ground truth user feedback in order to determine which networking actions can optimize the user experience. To that end a rich set of telemetry sources are gathered along with labeled user feedback to train Machine Learning model used to predict (for forecast) the user experience (aka QoE). Such a holistic approach end-to-end across layers is a paradigm shift to how networks have been designed and operated since the early days of the Internet.

### ——Ensemble-Based Detection of Anomalous Feedback in ML Modeling——

As noted above, many systems today, such as voice and/or video applications, often collect user feedback about quality-of-experience (QoE). As also noted, however, when directly collecting data from users, it is important to account for potentially adverse or unreliable behaviors. For instance, a small set of users may misunderstand what is expected from them or they may always provide incorrect feedback on purpose. In particular, this can be problematic in applications that build machine learning models to assess and/or optimize the QoE.

As further noted above, although machine learning techniques can usually deal with some level of noise in the labels provided to them, too much label noise can still impact model performance. When providing overall visibility at the level of the network, such noisy labels can also lead to incorrect figures (e.g., it can lead to over-estimating the number of users with consistently poor QoE).

A challenge to detect anomalous behaviors in such datasets lies in that the number of samples per user may be small. That is, although it is possible to collect large datasets in aggregate, each user may only contribute between zero to a handful of labels every week, making the use of traditional anomaly detection techniques difficult. There are also legitimate situations where a user may provide labels that may seem anomalous. For instance, for a video-conferencing application, a user whose laptop speakerphones are defective may report audio issues although all metrics and predictions may indicate no issue at all. In this case, there is a legitimate issue that cannot be captured easily by modeling, and the user's labels may appear at odds with all the rest of the evidence. In such a situation, a proper action might be to automatically report a case to the IT department, or to trigger a review of whether the feature set that the model is built upon suffers from some blind spots and may need to be extended to capture more potential failure scenarios.

Machine learning (ML) models make use of labels coming from a feature space that may have a number of dimensions, making the coverage of that space highly challenging if not impossible. Thus, a user may be reporting labels with a set of conditions that the model has not seen before, and which may be flagged as anomalous, although it is not, making the challenge of detecting anomalies even harder.

The techniques herein, therefore, provide an ensemble-based detection of anomalous feedback in machine learning modeling, particularly for QoE modeling. In particular, the techniques herein, as described in greater detail below, identify outliers in prediction residuals (i.e., quantifying how much a QoE model mis-predicted the user's outcome) from an ensemble of QoE models to mark feedback (e.g., users) as anomalous. For instance, manual or automated review based thereon can then be used to either prevent the corresponding accounts from participating in the labeling program when they are deemed to be adversarial, or else to escalate the issue (e.g., to an information technology (IT) or network engineering department) to improve on potential blind spots or recurring issues. The techniques described below are designed to work well on small number of samples per user and with a variety of types of QoE models. The aim of this techniques herein is to assist the administrator, who may be using bots to gather labels, in detecting unreliable users (labels) that would alter the efficacy of the QoE model.

Said differently, the techniques herein allow an administrator using a label collection engine (e.g., used to train a QoE model) to quickly identify labels that should not be used for training. As described below, a first component is used to compute residual error (labels with high model uncertainty), a second component clusters the labels with abnormal residual error, whereas a third component filters the most “offending” labels. A fourth component is used that allows the user of the system to investigate the exact circumstances that led to such uncertainty (“blind spot”, unreliable user/label or adversarial attack) so as to trigger the required remediation (e.g., improve the “blind spot” by acquiring additional labels in the same region of the input feature spaces, remove the user, determine whether the label is due to an adversarial attack, etc.).

Specifically, according to one or more embodiments of the disclosure as described in detail below, a method herein comprises: computing a plurality of predictions based on session telemetry data for an application, each of the plurality of predictions computed by inputting a particular input of the session telemetry data into a respective machine learning model of a plurality of machine learning models; computing, for each respective feedback of a plurality of collected feedbacks correlated with the session telemetry data, a residual error vector that quantifies a level of mis-prediction of each respective machine learning model as compared to each respective feedback; clustering each residual error vector into one or more clusters based on similarity to thereby identify one or more outlier residual error vectors that are not within any of the one or more clusters; and performing one or more mitigation actions responsive to the one or more outlier residual error vectors.

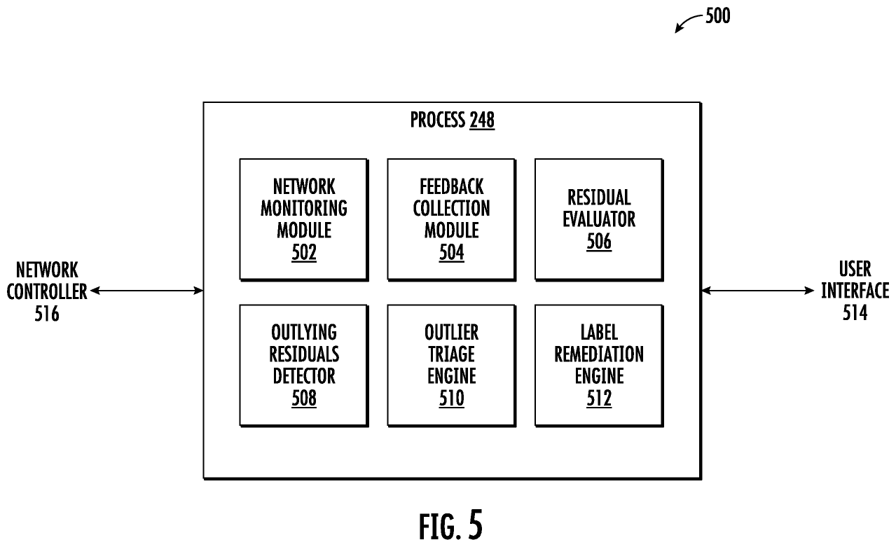

FIG. 5 illustrates an example architecture (architecture 500) for ensemble-based detection of anomalous feedback in machine learning modeling, according to various implementations. At the core of architecture 500 is anomalous feedback detection process (process 248), which may be executed by a controller for a network or another device in communication therewith. For instance, process 248 may be executed by a controller for a network (e.g., SDN controller 408 in FIGS. 4A-4B, a network controller in a different type of network, etc.), a particular networking device in the network (e.g., a router, a firewall, etc.), another device or service in communication therewith, or the like. In some embodiments, for instance, anomalous feedback detection process (process 248) may be used to implement a predictive application aware routing engine, such as predictive application aware routing engine 412, or another supervisory service for the network. In other embodiments, anomalous feedback detection process (process 248) may be used to implement a reactive routing approach in the network, e.g., in conjunction with one or more functional processes 246, as described above.

As shown, anomalous feedback detection process (process 248) may include any or all of the following components: network monitoring module 502, a feedback collection module 504, a residual evaluator 506 or “RE”, an outlying residuals detector 508 or “ORD, an outlier triage engine 510 or “OTE”, and a label remediation engine 512 or “LRE. As would be appreciated, the functionalities of these components may be combined or omitted, as desired (e.g., implemented as part of process 248). In addition, these components may be implemented on a singular device or in a distributed manner, in which case the combination of executing devices can be viewed as their own singular device for purposes of executing a process 248. Also, anomalous feedback detection process (process 248) may be in communication with one or more user interfaces (user interface 514) and one or more network controllers 516, accordingly.

Operationally, the techniques herein may rely on an external user feedback dataset or mechanism to collect user feedback on application quality-of-experience. This dataset combines network and application telemetry with real user feedback, also referred to as “labels”. The data can be collected by polling the users about their subjective experience during an application session and then matching each collected label with the session telemetry recorded prior to the feedback. For example, certain implementations of the techniques herein may collect direct user experience metrics for an online application via a chatbot, which may be integrated directly into the online application (e.g., Webex, Slack, WhatsApp bots, etc.). In other words, a chatbot may act as a relay between the network and end users of a given application, querying live feedback about their experience.

Illustratively, certain aspects of a system in accordance with the techniques herein may associate one or more performance metrics with a particular session of an online application, and may obtain feedback from users regarding their application experience, such as by causing a chatbot to query the user for feedback regarding their application experience. The techniques herein may then associate the feedback from the user regarding their application experience with the one or more performance metrics.

In particular, network monitoring module 502 may monitor the traffic of users of an online application in (near) real-time (e.g., continuously), in some embodiments. In general, the role of network monitoring module 502 is to identify when users of a given online application are active and, optionally, obtain a (rough) assessment of the quality of service provided by the network for their sessions. To this end, network monitoring module 502 may typically be hosted on a network device (a router, wireless LAN controller, etc.) or a network controller (e.g., DNA Center, vManage, etc.) and process network telemetry related to the application traffic and path QoS. For instance, such telemetry may take the form of NetFlow records, BFD probing results, IP-SLA information, or the like. In further embodiments, another form of telemetry that network monitoring module 502 may obtain could be application-level metrics measured by the application itself. For instance, such application-level metrics may include metrics such as application-measured loss, latency, jitter, concealment time, codec statistics, audio/video bitrates, or the like. For instance, the application itself may provide this telemetry to network monitoring module 502 via an application programming interface (API) or other mechanism. In some instances, network monitoring module 502 may also be cloud-hosted and process the application-level telemetry, directly. Further embodiments provide for multiple network monitoring modules to be implemented at different locations, as well.

Feedback collection module 504, in various embodiments, may be responsible for collecting user feedback in a variety of manners, such as by presenting a chatbot to the user interface of select users, or by a simple rating, ranking, or “thumbs up” or “thumbs down” vote. In various embodiments, such a feedback engine may be integrated directly into the online application itself or presented via a separate agent or other mechanism. For instance, assume that the online application is Webex. In such a case, feedback collection module 504 may cause a chatbot or other feedback mechanism to be displayed to a selected videoconference user.

Feedback collection module 504 may use different strategies to collect the feedback, such as any or all of the following, in various embodiments:
Classical surveying with a 1-to-5 stars rating or similar. This is useful in case of random surveys and/or when the system has a poor estimate of the experience (e.g., upon bootstrapping the system).
Direct yes/no question—e.g., “It seems you are having a very bad time with O365. Am I correct?” This is useful when the system has a good estimate of the user experience and wants to establish trust. Ideally, such queries should be accompanied of a tip or piece of advice to resolve the situation such as “You may improve your experience by switching to cellular,” “You are now using a 5G link, are you seeing any improvement in term of experience during this call?” or the like.

In further embodiments, feedback collection module 504 may also leverage natural language interactions, either initiated by the chatbot or not.

Once feedback collection module 504 has collected the actual user feedback regarding their application experiences, it may associate this information with the telemetry obtained by network monitoring module 502. For instance, in the case of process 248 being used to implement predictive application aware routing engine 412, shown previously, the feedback could be used as ground truth information for purposes of training a predictive model to predict whether the application experience is acceptable or not, given the network-level and/or application-level telemetry that is available. Such associations can also be used for purposes of presenting information to a network operator (e.g., by showing the operator the effects of a configuration change or event on the application experience of users, etc.).

Optionally, network monitoring module 502 may also include state collector agent, which collects and stores more detailed state information about networking devices (e.g., edge devices, routers, switches) at the time a feedback request was sent by feedback collection module 504 to a user, in some embodiments. Such states are often of the utmost importance for models in charge of predicting and/or forecasting application QoE. In addition to the telemetry collected by network monitoring module 502, which is designed to be quite sparse and lightweight, a state collector agent may send instructions to the various networking elements/devices (e.g., routers, switches) along the path followed by the application traffic (e.g., number of hops, types of links, links state, congestion level, error rates, etc.), to collect more detailed information about their state. Typically, such detailed information could not be collected by network monitoring module 502 in the first place because of scaling issues. More specifically, network monitoring module 502 will typically process all telemetry, whereas a state collector agent (whether a part of network monitoring module 502 or a separate module) may be used selectively obtain information for flows associated with user feedback. In addition, network monitoring module 502 may also interact with other mechanisms, to train the machine learning models of a predictive routing engine, to predict application QoE (e.g., as described in greater detail below) and/or by performing closed-loop control over the network. Should such mechanisms require additional input features, a state collector agent component of network monitoring module 502 could be used to gather this state information.

As noted above, the user feedback dataset provides feedback on application quality-of-experience (QoE), and combines network and application telemetry with real user feedback, also referred to as “labels”, where subjective experience during an application session may be correlated by matching each collected label with the session telemetry recorded prior to the feedback. The labels themselves can be binary (e.g., “thumbs-up-My experience is good”/“thumbs-down-My experience is bad”) or continuous (e.g., a rating between 1 and 5), and may be associated to a feature vector (e.g., session telemetry) describing the application and client state around the moment where the label was collected (e.g., in the previous fifteen minutes). For example, in a video-conferencing application, the feature vector can include information such as network latency/jitter better the client and the media server, audio and video bitrates, indicators about possible concealments of successive video frames, etc. Note that techniques herein are not limited to these feedback collection mechanisms, and a variety of situations where feedback labels are collected, whether from a user or from other sources, accordingly.

According to the techniques herein, whenever a user provides a label, the residual evaluator 506 or “RE” is responsible for computing residual scores for that label and the corresponding feature vector. To do so, the RE uses an ensemble of QoE models trained on the dataset. If there is a main QoE model as in Predictive Networks or Cognitive Networks, this model can be included in the ensemble. Additional models can be added to the ensemble as well: either (i) trained using the same method and architecture as the main QoE model but with different initializations, subsampling or feature masking, or (ii) trained using different methods and architectures. The goal of the ensemble of models is to provide a notion of uncertainty on the prediction, and to potentially capture different types of patterns.

For each instance with feature vector x and label y, the residual evaluator 506 produces a residual vector of the form: R(x)=[R1(x), R2(x), R3(x), . . . ], where Ri(x) is the residual for the i-th model (e.g., for regression models, the difference between the label and a continuous prediction in the same range as the target range). A residual with a large absolute value indicates that the model was far off in the prediction. The sign of the residual carries useful information, indicating whether the model has predicted a value that was too high or too low.

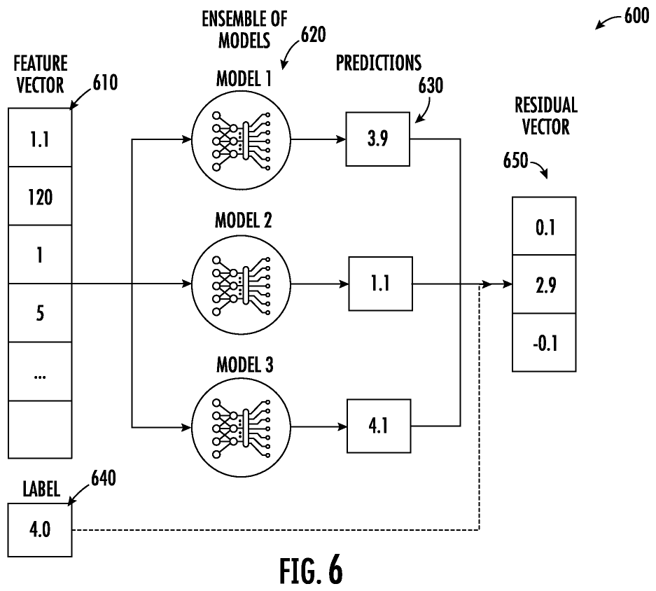

FIG. 6 illustrates an example system (system 600) for computing a residual vector for a single sample and label. As shown, feature vectors 610 may be input into the ensemble of models 620, e.g., “model 1”, “model 2”, “model 3”, etc. Each model may then produce their own predictions (predictions 630), e.g., predictions of QoE as described herein, or other predictions for which the models are trained to infer. By now comparing the label 640 to the predictions 630, the techniques herein may thus produce residual vector 650, accordingly. For instance, from predictions 630 of “3.9”, “1.1”, and “4.1”, the resultant residual vector (residual vector 650) when compared to a label of “4.0” would illustratively be [“0.1”, “2.9”, “−0.1”]. (As can be seen, model 1 was slightly low, model 3 was slightly high, and model 2 was off by a relatively large amount.

In one implementation, the residual vector can also be extended with additional information on how the feedback was provided: e.g., if the data collection supports it, information about how long it took the feedback to be provided (e.g., by the user) or other signals can be incorporated. Even in this case, the techniques herein still refer to the resulting data vector as the “residual vector” going forward for simplicity.

Optionally, the residual evaluator 506 can also attach contextual information to each residual vector for troubleshooting, such as in the steps described further below. For example, scores such as Shapely Values can be provided to help interpret which signals were predominant in each model's prediction. Notably, a Shapely value explains how much the feature contributes to the prediction and what is the magnitude of this contribution. A positive Shapley value indicates that the feature contributes positively to the prediction; a negative value means a negative contribution.

According to the techniques herein, the outlying residuals detector 508 or “ORD” takes as inputs residual vectors, and periodically runs a clustering algorithm over those residual vectors to identify outliers—i.e., residual vectors that are away from other residual vectors. In a well-tuned system where the QoE model achieves high accuracy, most residual vectors should cluster around the origin (i.e., they should all be close to the all-zeroes vector). To this end, an algorithm that can leave points unclustered when they are too far from other points can be used in the ORD, such as a density-based method like density-based spatial clustering of applications with noise (DBSCAN, or DB-SCAN) or variants of it. Points that are left unclustered at the end of the processed are referred to as “noise points” or “outliers”.

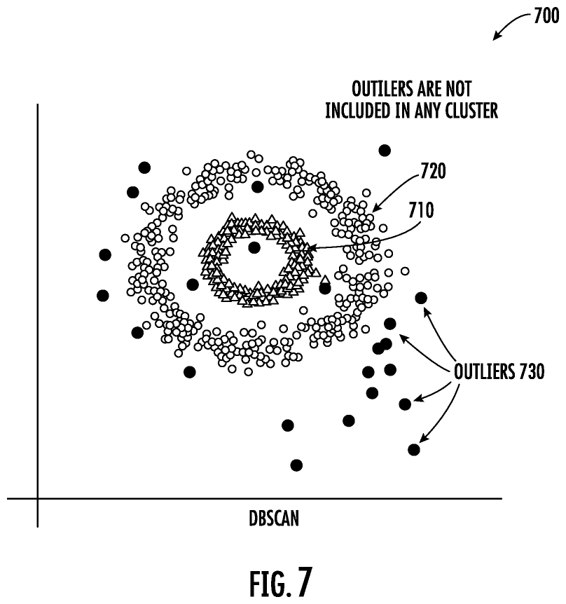

FIG. 7 illustrates an example of a DBSCAN (plot 700) in a two-dimensional space showing clusters (inner cluster 710 and outer cluster 720) and outliers 730. In the techniques herein, the space has more dimensions due to the use of multiple models in the ensemble, and two dimensions are shown herein for simplicity.

Clustering can operate on all labels acquired. However, after a while, the space with all residual vectors can clutter up, making it harder to detect outliers, and clustering can also become slow. Hence, it can be beneficial to use a temporal sliding window and only cluster based on labels acquired in a fixed time interval. This is also consistent with the goals of the procedure, as it would often be better to react to anomalous user feedback in a timely manner after it has been produced.

Clustering can also operate on a dataset where points that have previously marked as outliers have been removed, to make way for new outliers. However, this must be tuned carefully to make sure density can still build up over time in legitimate areas of the space.

For each user, the outlying residuals detector 508 outputs statistics about the number and fraction of points that have been marked as outlier:
User 1:5 points, 0 outliers;
User 2:8 points, 0 outliers;
User 3:6 points, 4 outliers.

A user interface 514 (UI) is specified herein to allow an admin of the system to clearly identify the label outliers for which the model is highly uncertain and the related context (e.g., a user ID, networking circumstances, etc.) so as to determine whether the label is due to a model having a “blind spot” or a user providing unreliable label or some adversarial attacks from a user. The root cause is key for identifying the necessary remediation action.

According to the techniques herein, the outlier triage engine 510 or “OTE” takes as input the output statistics from the outlying residuals detector 508 and the per-sample contextual information from the residual evaluator 506 (e.g., the Shapely Values), and triages users (or more generally, sources of feedback) into one of four buckets:
Large number of outliers, which could be unreliable or adversarial.
Large number of outliers, which could be a blind spot with model or data.
Large number of outliers, cause unknown.
Normal.

The classification above can be based on simple heuristics (e.g., thresholds such as: if there are at least 3 outliers and 5 points, do not put in the ‘Normal’ bucket).

The label remediation engine 512 or “LRE” may then be used to trigger the necessary mitigation action according to the root cause. The user of the system will have access to the contextual information to determine whether the “outliers” (label with high residual error) after triage from the outlier triage engine 510 is due to a model with a blind spot or a source (e.g., user) providing unreliable label or even some adversarial attack. In the first case, the system may decide to solicit the source/user for gathering more labels to improve the model. In another embodiment a network scanning process may be trigger to identify other potential sources/users experiencing similar network conditions for whom labels should be gathered to improve the QoE model.

Upon gathering labels with similar conditions, the outlying residuals detector 508 should be rerun in order to determine whether the label for which the residual was high does indeed decrease. In the case where an admin of the system determines that the high residual is due to some unreliable sources/users, the admin may simply decide to discard the labels from the label dataset with (or without) further notification to the users. In the last scenario where the labels seems to be due to some adversarial attacks, labels should be ignored and additional measures could be taken.

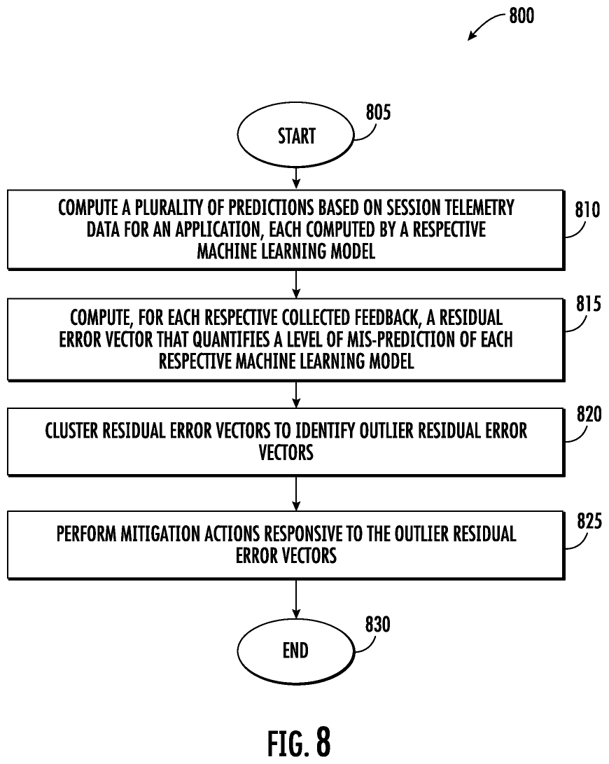

FIG. 8 illustrates an example simplified procedure for ensemble-based detection of anomalous feedback in machine learning modeling in accordance with one or more embodiments described herein. For example, a non-generic, specifically configured device (e.g., device 200, an apparatus) may perform procedure 800 by executing stored instructions (e.g., process 248). The procedure 800 may start at step 805, and continues to step 810, where, as described in greater detail above, the techniques herein compute a plurality of predictions (e.g., quality-of-experience predictions) based on session telemetry data for an application, each of the plurality of predictions computed by inputting a particular input of the session telemetry data into a respective machine learning model of a plurality of machine learning models. As described above, in one implementation the plurality of machine learning models may be based on a single model trained using a single method and architecture but with different initializations, subsampling, and/or feature masking. In another implementation, the plurality of machine learning models may be based on a plurality of different models trained on different methods and/or architectures.

In step 815, the techniques herein may compute, for each respective feedback of a plurality of collected feedbacks (e.g., quality-of-experience feedbacks) correlated with the session telemetry data, a residual error vector that quantifies a level of mis-prediction of each respective machine learning model as compared to each respective feedback. For instance, the techniques herein may collect the plurality of collected feedbacks based on polling users about their subjective experience during an application session, and then correlating each of the plurality of collected feedbacks with a respective input of the session telemetry data.

In step 820, the techniques herein may then cluster each residual error vector into one or more clusters based on similarity to thereby identify one or more outlier residual error vectors that are not within any of the one or more clusters. For instance, as noted above, clustering may be based on density-based spatial clustering of applications with noise (DBSCAN). As also noted above, clustering may be limited based on a temporal sliding window.

In step 825, the techniques herein may perform one or more mitigation actions responsive to the one or more outlier residual error vectors. In particular, as described in greater detail above, the one or more mitigation actions are selected from a group consisting of:
marking one or more specific feedbacks of the plurality of collected feedbacks associated with the one or more outlier residual error vectors as anomalous;
marking one or more specific sources of the plurality of collected feedbacks associated with the one or more outlier residual error vectors as anomalous;
marking one or more specific sources of the plurality of collected feedbacks associated with the one or more outlier residual error vectors as unreliable;
investigating circumstances that led to the one or more outlier residual error vectors;
performing remediation against an adversarial feedback attack based on the one or more outlier residual error vectors;
and so on.

Also, in a particular implementation, the one or more mitigation actions may comprise discarding one or more specific feedbacks of the plurality of collected feedbacks associated with the one or more outlier residual error vectors from use in training the plurality of machine learning models. In still a further implementation, the one or more mitigation actions may comprise preventing feedback participation from one or more specific sources of the plurality of collected feedbacks associated with the one or more outlier residual error vectors that are deemed to be adversarial.

Also, in certain embodiments and situations, the techniques herein may also attach contextual troubleshooting information to the one or more outlier residual error vectors. For instance, the contextual troubleshooting information may be selected from a group consisting of: additionally solicited feedback from sources of the plurality of collected feedbacks associated with the one or more outlier residual error vectors; additionally solicited feedback from new sources; indications of predominant signals used in computing the plurality of predictions; information on how the plurality of collected feedbacks was provided; and so on.

Procedure 800 may end at step 830. Notably, additional refinements may also be performed based on the steps above, such as, e.g., removing the one or more outlier residual error vectors from consideration in clustering, and re-clustering each residual error vector other than the one or more outlier residual error vectors to thereby further identify one or more additional outlier residual error vectors. Another such refinement may comprise recomputing a new plurality of predictions based on the session telemetry data with one or more specific feedbacks of the plurality of collected feedbacks associated with the one or more outlier residual error vectors being removed, and confirming that the new plurality of predictions is an improvement on the plurality of predictions.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: computing a plurality of predictions based on session telemetry data for an application, each of the plurality of predictions computed by inputting a particular input of the session telemetry data into a respective machine learning model of a plurality of machine learning models; computing, for each respective feedback of a plurality of collected feedbacks correlated with the session telemetry data, a residual error vector that quantifies a level of mis-prediction of each respective machine learning model as compared to each respective feedback; clustering each residual error vector into one or more clusters based on similarity to thereby identify one or more outlier residual error vectors that are not within any of the one or more clusters; and performing one or more mitigation actions responsive to the one or more outlier residual error vectors.

In still other implementations, a tangible, non-transitory, computer-readable medium storing program instructions that cause a device to execute a process comprising: computing a plurality of predictions based on session telemetry data for an application, each of the plurality of predictions computed by inputting a particular input of the session telemetry data into a respective machine learning model of a plurality of machine learning models; computing, for each respective feedback of a plurality of collected feedbacks correlated with the session telemetry data, a residual error vector that quantifies a level of mis-prediction of each respective machine learning model as compared to each respective feedback; clustering each residual error vector into one or more clusters based on similarity to thereby identify one or more outlier residual error vectors that are not within any of the one or more clusters; and performing one or more mitigation actions responsive to the one or more outlier residual error vectors.

The techniques described herein, therefore, provide for ensemble-based detection of anomalous feedback in machine learning modeling, particularly for QoE modeling (though other ML modeling may also use the techniques herein). In particular, the techniques herein address the challenges of detecting anomalous behaviors in feedback datasets, particularly user feedback where the number of samples per user may be small, the feedback is unrelated to the actual issue, or the feedback is specifically adversarial. Note, too, that while adversarial label noise-when adversaries provide purposefully incorrect labels with the aim of influencing the learning in a specific direction—has been addressed to allow models to be directly resistant to it, the techniques herein further address unreliable labels (which need not be adversarial), and are focused on user feedback (and specific users) when working with QoE modeling, in particular.

Additionally, more than merely determining ratings of network anomalies detected by a network assurance system (e.g., where the ratings are provided by network operators and pertain to the relevance of the anomaly from a network standpoint) and excluding “bad rankers”, the techniques herein are directed toward experience ratings provided by end users of a given application, where such QoE ratings are critical to the training of a proper QoE model, and the quality of this dataset is of utmost importance. Because QoE labels are a lot more difficult to acquire, the techniques herein therefore suggest more advanced strategies and triaging than a simple exclusion. That is, the techniques herein perform triaging and remediation in case of unreliable or adversarial labels, poor modeling, or an unknown cause, which are generally specific to the QoE modeling use case (e.g., searching for other users with similar network conditions to confirm or replace the unreliable labels).

Illustratively, the techniques described herein may be performed by hardware, software, and/or firmware, (e.g., an “apparatus”) such as in accordance with the anomalous feedback detection process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
computing, by a device, a plurality of predictions based on session telemetry data for an application, each of the plurality of predictions computed by inputting a particular input of the session telemetry data into a respective machine learning model of a plurality of machine learning models;
computing, by the device and for each respective feedback of a plurality of collected feedbacks correlated with the session telemetry data, a residual error vector that quantifies a level of mis-prediction of each respective machine learning model as compared to each respective feedback;
clustering, by the device, each residual error vector into one or more clusters based on similarity to thereby identify one or more outlier residual error vectors that are not within any of the one or more clusters; and
performing, by the device, one or more mitigation actions responsive to the one or more outlier residual error vectors.

2. The method of claim 1, wherein the one or more mitigation actions are selected from a group consisting of:
marking one or more specific feedbacks of the plurality of collected feedbacks associated with the one or more outlier residual error vectors as anomalous;
marking one or more specific sources of the plurality of collected feedbacks associated with the one or more outlier residual error vectors as anomalous;
marking one or more specific sources of the plurality of collected feedbacks associated with the one or more outlier residual error vectors as unreliable;
investigating circumstances that led to the one or more outlier residual error vectors; and
performing remediation against an adversarial feedback attack based on the one or more outlier residual error vectors.

3. The method of claim 1, wherein the plurality of machine learning models are based on a single model trained using a single method and architecture but with different initializations, subsampling, and/or feature masking.

4. The method of claim 1, wherein the plurality of machine learning models are based on a plurality of different models trained on different methods and/or architectures.

5. The method of claim 1, wherein the plurality of predictions comprise quality-of-experience predictions, and wherein the plurality of collected feedbacks comprise quality-of-experience feedbacks.

6. The method of claim 1, further comprising:
attaching contextual troubleshooting information to the one or more outlier residual error vectors.

7. The method of claim 6, wherein the contextual troubleshooting information is selected from a group consisting of: additionally solicited feedback from sources of the plurality of collected feedbacks associated with the one or more outlier residual error vectors; additionally solicited feedback from new sources; indications of predominant signals used in computing the plurality of predictions; and information on how the plurality of collected feedbacks was provided.

8. The method of claim 1, wherein clustering is based on density-based spatial clustering of applications with noise.

9. The method of claim 1, wherein clustering is limited based on a temporal sliding window.

10. The method of claim 1, further comprising:
removing the one or more outlier residual error vectors from consideration in clustering; and
re-clustering each residual error vector other than the one or more outlier residual error vectors to thereby further identify one or more additional outlier residual error vectors.

11. The method of claim 1, wherein the one or more mitigation actions comprise discarding one or more specific feedbacks of the plurality of collected feedbacks associated with the one or more outlier residual error vectors from use in training the plurality of machine learning models.

12. The method of claim 1, wherein the one or more mitigation actions comprise preventing feedback participation from one or more specific sources of the plurality of collected feedbacks associated with the one or more outlier residual error vectors that are deemed to be adversarial.

13. The method of claim 1, further comprising:
recomputing a new plurality of predictions based on the session telemetry data with one or more specific feedbacks of the plurality of collected feedbacks associated with the one or more outlier residual error vectors being removed; and
confirming that the new plurality of predictions is an improvement on the plurality of predictions.

14. The method of claim 1, further comprising:
collecting the plurality of collected feedbacks based on polling users about their subjective experience during an application session; and
correlating each of the plurality of collected feedbacks with a respective input of the session telemetry data.

15. An apparatus, comprising:
one or more network interfaces to communicate with a network;
a processor coupled to the one or more network interfaces and configured to execute one or more processes; and
a memory configured to store a process that is executable by the processor, the process comprising:
computing a plurality of predictions based on session telemetry data for an application, each of the plurality of predictions computed by inputting a particular input of the session telemetry data into a respective machine learning model of a plurality of machine learning models;
computing, for each respective feedback of a plurality of collected feedbacks correlated with the session telemetry data, a residual error vector that quantifies a level of mis-prediction of each respective machine learning model as compared to each respective feedback;
clustering each residual error vector into one or more clusters based on similarity to thereby identify one or more outlier residual error vectors that are not within any of the one or more clusters; and
performing one or more mitigation actions responsive to the one or more outlier residual error vectors.

16. The apparatus of claim 15, wherein the one or more mitigation actions are selected from a group consisting of:
marking one or more specific feedbacks of the plurality of collected feedbacks associated with the one or more outlier residual error vectors as anomalous;
marking one or more specific sources of the plurality of collected feedbacks associated with the one or more outlier residual error vectors as anomalous;
marking one or more specific sources of the plurality of collected feedbacks associated with the one or more outlier residual error vectors as unreliable;
investigating circumstances that led to the one or more outlier residual error vectors; and
performing remediation against an adversarial feedback attack based on the one or more outlier residual error vectors.

17. The apparatus of claim 15, wherein the plurality of predictions comprise quality-of-experience predictions, and wherein the plurality of collected feedbacks comprise quality-of-experience feedbacks.

18. The apparatus of claim 15, the process further comprising:
attaching contextual troubleshooting information to the one or more outlier residual error vectors.

19. The apparatus of claim 15, wherein the one or more mitigation actions are selected from a group consisting of:
discarding one or more specific feedbacks of the plurality of collected feedbacks associated with the one or more outlier residual error vectors from use in training the plurality of machine learning models; and
preventing feedback participation from one or more specific sources of the plurality of collected feedbacks associated with the one or more outlier residual error vectors that are deemed to be adversarial.

20. A tangible, non-transitory, computer-readable medium storing program instructions that cause a device to execute a process comprising:
computing a plurality of predictions based on session telemetry data for an application, each of the plurality of predictions computed by inputting a particular input of the session telemetry data into a respective machine learning model of a plurality of machine learning models;
computing, for each respective feedback of a plurality of collected feedbacks correlated with the session telemetry data, a residual error vector that quantifies a level of mis-prediction of each respective machine learning model as compared to each respective feedback;
clustering each residual error vector into one or more clusters based on similarity to thereby identify one or more outlier residual error vectors that are not within any of the one or more clusters; and
performing one or more mitigation actions responsive to the one or more outlier residual error vectors.
